(19) United States
(12) Patent Application Publication
(10) Pub. No.: US 2016/0221806 A1
(43) Pub. Date: Aug. 4, 2016

(54) CRANE COMPRISING A CONICAL PEDESTAL

(71) Applicant: KALKMAN IP B.V., Waddinxveen (NL)

(72) Inventor: Pieter KALKMAN, Waddinxveen (NL)

(21) Appl. No.: 14/916,036

(22) PCT Filed: Sep. 2, 2014
(86) PCT No.: PCT/NL2014/050595

§ 371 Date: Mar. 2, 2016

(30) Foreign Application Priority Data
Sep. 2, 2013 (NL) 2011368

(51) Int. Cl. B66C 23/84; B66C 23/00

(52) U.S. Cl. CPC B66C 23/84; B66C 23/00

(57) ABSTRACT

A crane includes a pedestal having a circular periphery, a base supported with respect to the pedestal so as to be rotatable along a substantially vertical axis, a boom fitted to the base so as to be rotatable along a horizontal axis and adjustment elements for adjusting the angle of inclination of the boom. The base is provided with a series of rolling elements which each have a substantially vertical axis, which series of rolling elements can be rolled over the circular periphery of the pedestal and which is always situated on the pedestal facing the boom. As a result, the series of rolling elements is subjected to a tensile load on account of the torque exerted on the pedestal by the boom and is held against the circular periphery of the pedestal. In order to simplify the construction, the base is designed as having a strip-shaped pulling element.

The invention relates to a crane, comprising a pedestal having a circular periphery, a base which is supported with respect to the pedestal so as to be rotatable along a substantially vertical axis, a boom which is fitted to the base so as to be rotatable along a horizontal axis, as well as adjustment means for adjusting the angle of inclination of the boom, which base is provided with a series of rolling elements which each have a substantially vertical axis, which series of rolling elements can be rolled over the circular periphery of the pedestal and which is always situated on that side of the pedestal facing the boom in such a manner that the series of rolling elements is subjected to a tensile load on account of the torque exerted on the pedestal by the boom and is held against the circular periphery of the pedestal.

Such a crane is known from EP-A-1606211. This known crane has a series of rolling elements which are arranged according to a chain. The chain has links which are pivotably connected to each other. At the location of each pivot, there is a rotatable rolling element. On account of the torque which is exerted by the boom and the lifting load which is optionally suspended therefrom, this chain is subjected to a tensile load and thus pulled taut around and against the pedestal. As a result thereof, the rolling elements are in turn pushed against the running surface surrounding the pedestal. This makes it possible for the crane to execute a rotary movement.

The drawback of such a chain with rotatably connected links is that it is heavy and large. After all, the loads are great, which means that each pivot between the links is also subjected to a great load. Since failure of one of the pivots could result in the collapse of the crane, these have to be very reliable. Therefore, these pivots have to be of a robust design. At the location of the pivot points, the rollers also have to be rotatably suspended, causing further complications.

It is therefore an object of the invention to provide a crane of the above-mentioned type having a relatively simple and less heavy mounting which nevertheless has an equally high degree of reliability. This object is achieved by the fact that the series of rolling elements comprises a pulling element which is strip-shaped, that the width direction of the pulling element is parallel to the axis of the rolling elements, that the thickness direction of the pulling element is radial with respect to the circular periphery of the pedestal, that the height of the pulling element is greater than the width thereof and that the rolling elements are suspended from the pulling element.

The pulling element is a relatively simple mechanical component which can be produced in an inexpensive manner. Such a pulling element does not in itself have to comprise any moving components. The pulling element may consist of a continuous web of material or several laminated continuous webs of material. The expression “continuous web of material” has to be understood as a web which either consists of a single unit or consists of several webs which are placed in succession and are rigidly connected to each other. The pulling element may also consist of parts which are pivotably connected to each other and which extend over a part of the rolling elements, such as a quarter of the rolling elements, a third of the rolling elements, or for example over half the rolling elements. Preferably, one single pulling element extends over all rolling elements.

The associated end flanges on the ends of such a continuous web of material may analogously optionally form an integral part of said web. Such a strip-shaped pulling element is very reliable as no vulnerable pivot connections have to be used which could fail. In general, the design of the strip-shaped pulling element is adapted to the shape of the running surface on which the rolling elements roll over the pedestal. As it is also possible for the pulling element to be slightly bent on account of the loads which are applied thereto by the boom and any lifting loads, the rolling elements can be held against the running surface in a reliable manner. In this way, it is also possible to ensure a uniform distribution of the radial loads on the various rolling elements.

The rolling elements can be arranged in various ways on the pulling element. According to a first possibility, the rolling elements may be suspended from that surface of the pulling element which faces the pedestal. In that case, the rolling elements are situated in the hollow space as defined within the pulling element. According to another possibility, the rolling elements may be accommodated in an opening in the pulling element. This opening may, for example, be in the shape of a continuous slot-shaped opening; but it is also possible for each rolling element or combination of rolling elements to be accommodated in separate slots.

With regard to driving the base and the boom around the pedestal, a pinion may be supported so as to be rotatable along a substantially vertical axis with respect to the pulling element; in which case the pedestal is provided with a gear ring with which the pinion cooperates. The pinion is in turn connected to a motor for rotating the base with respect to the pedestal. The position of such a pinion may be the same as that of the rolling elements, that is to say entirely on the inside of the pulling element or in a slot in said pulling element.

In the latter case, the rolling elements and/or a pinion may be suspended from that surface of the pulling element which faces away from the pedestal. Alternatively, they may be suspended from that surface of the pulling element which faces the pedestal.

If desired, the rolling elements may be accommodated in a housing in pairs, which housing is attached to the pulling element. It is also possible for a pinion to be accommodated in the housing. As mentioned above, the pulling element may be strip-shaped and comprise a steel belt material. If desired, the strip-shaped pulling element may comprise a laminate of layers having a high tensile strength. In particular, the strip-shaped pulling element may comprise a semicircular part.

Both ends of the strip-shaped pulling element may be provided with flanges which are attached to the base, to which base the boom is fitted so as to be rotatable. Furthermore, the frame may comprise a tower, the upper end of which is rotatably supported by means of a pivot bearing and a radial bearing on the top of the pedestal, over which tower the adjustment means of the boom are passed. The base may comprise crane jibs which are attached to the ends of the strip-shaped pulling element. A cross beam may extend between the crane jibs. Between the crane jibs and/or the cross beam, on the one hand, and the pivot bearing and radial bearing, supports may extend for transferring vertical loads on the pivot bearing. The pedestal may have a cylindrical foundation and a conical top which is provided on the foundation. However, instead of using a pivot bearing, it is also possible to support the base by means of rolling elements having a radial axis with respect to the pedestal, in particular with respect to a horizontal flange which is attached thereto.

The invention will be explained in more detail below by means of an exemplary embodiment illustrated in the figures, in which:

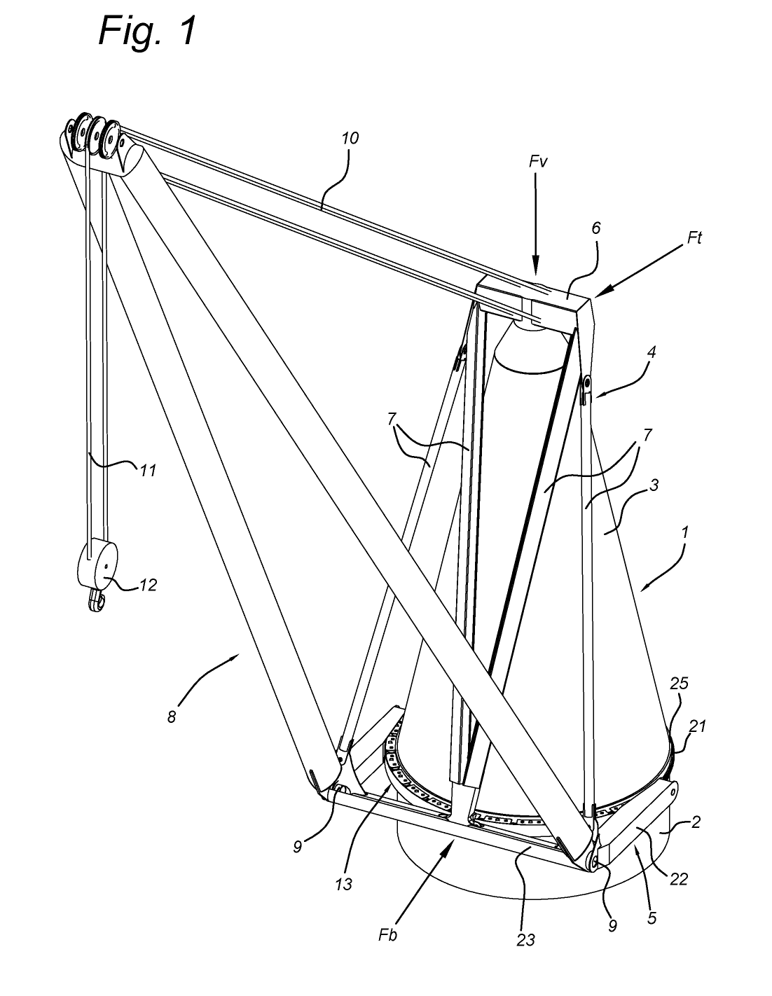

FIG. 1 shows a perspective view of the crane.

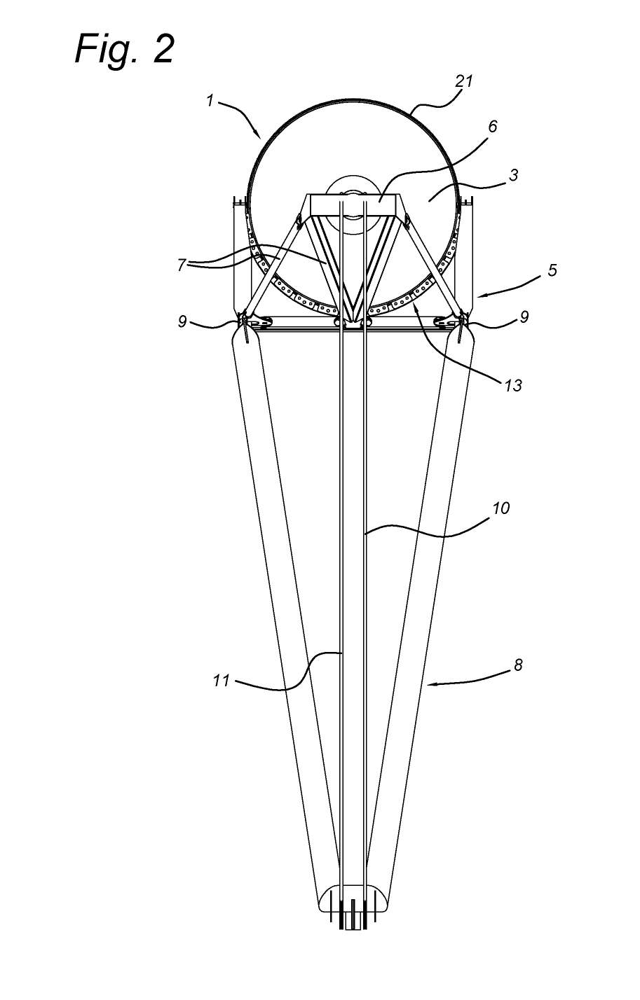

FIG. 2 shows a plan view of the crane.

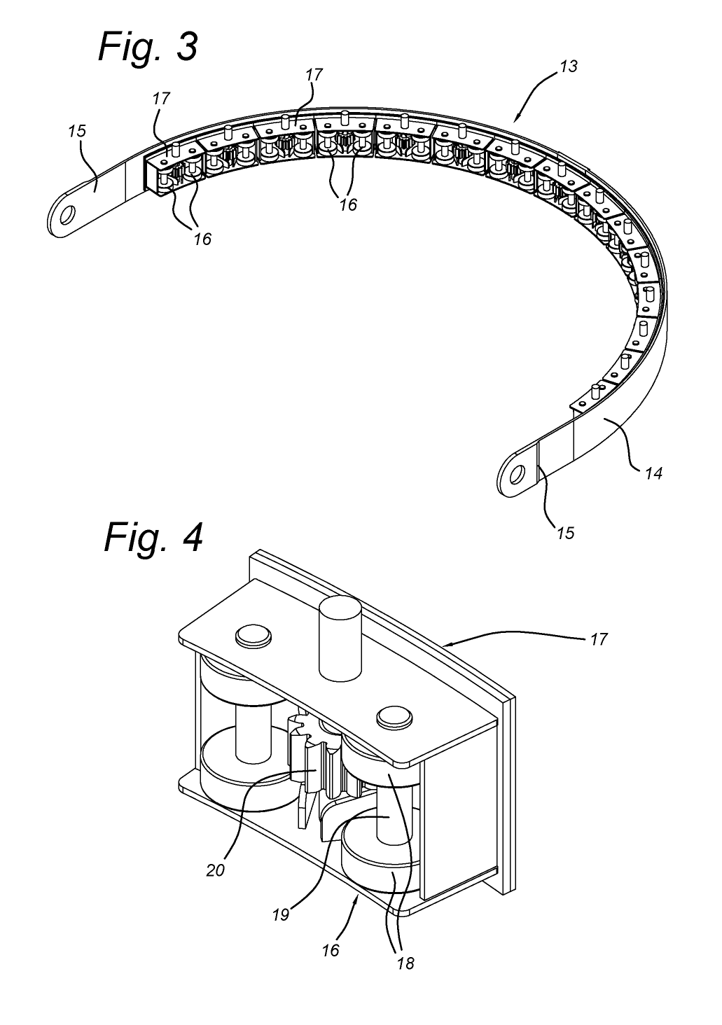

FIG. 3 shows a perspective view of a first embodiment of the pulling belt comprising rolling elements.

FIG. 4 shows a housing comprising rolling elements and a pinion.

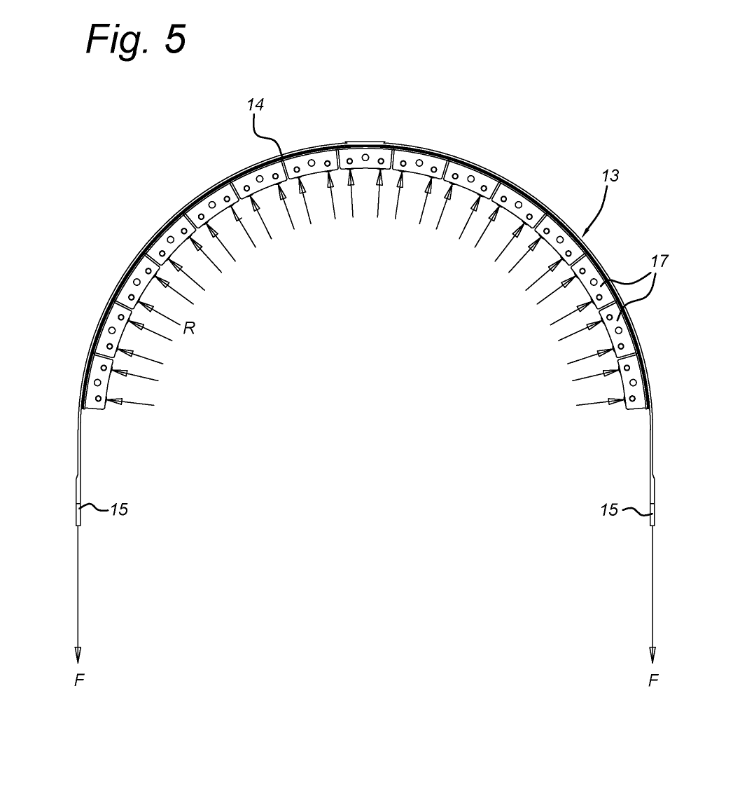

FIG. 5 shows a load diagram for the series of rolling elements.

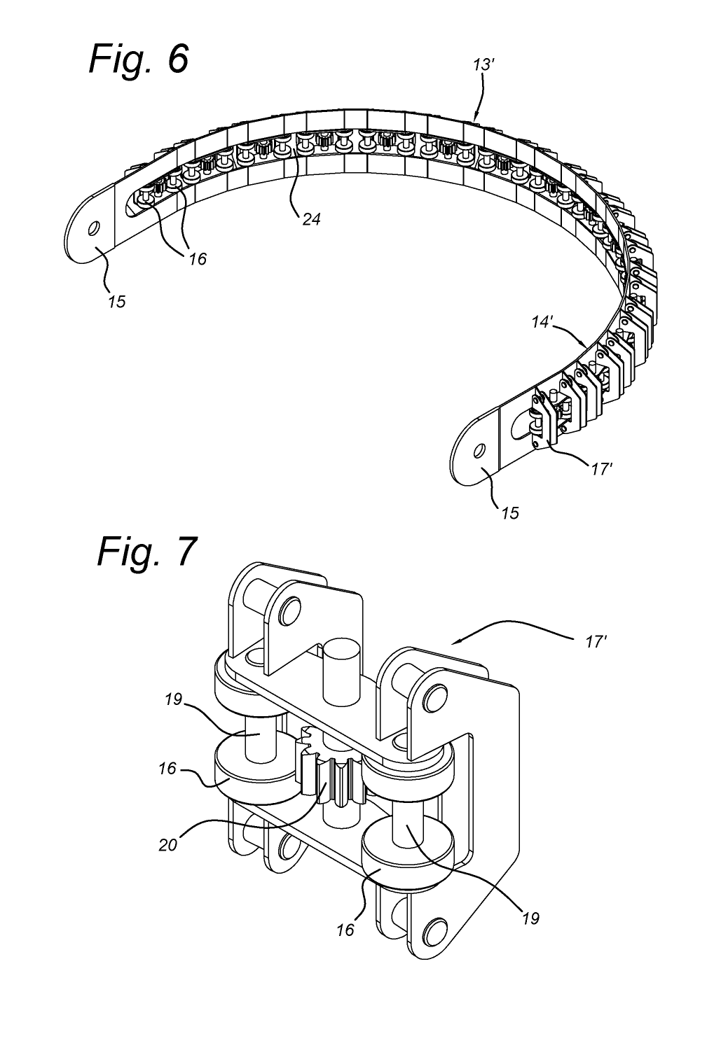

FIG. 6 shows a perspective view of a second embodiment of the pulling belt comprising rolling elements.

FIG. 7 shows a second embodiment of the housing comprising rolling elements and a pinion.

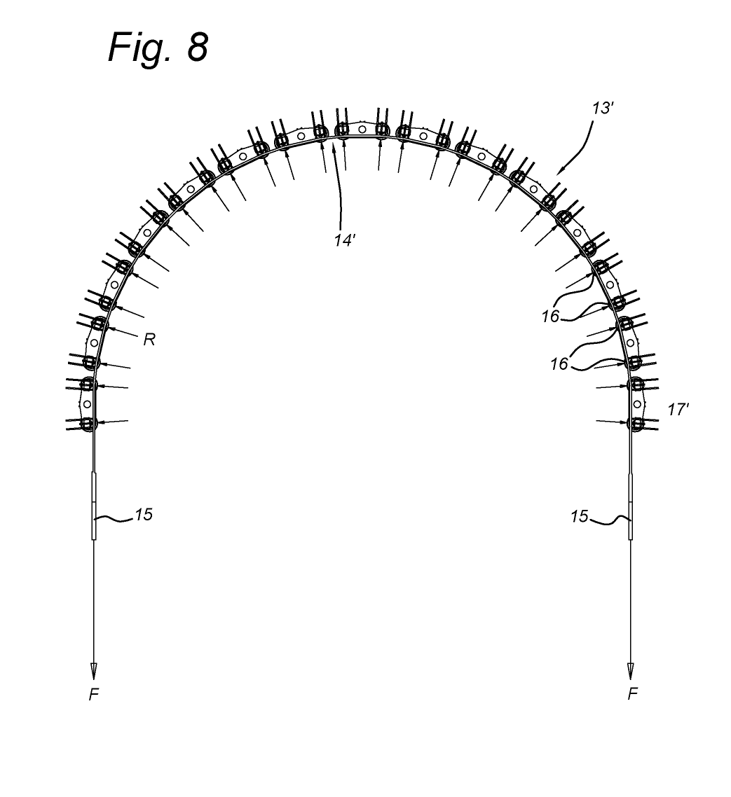

FIG. 8 shows a load diagram for the series of rolling elements according to the second embodiment.

The crane illustrated in FIGS. 1 and 2 has a pedestal which is denoted overall by reference numeral 1 and has a bottom pedestal section 2 having a cylindrical shape and a conical top 3. The frame which is denoted overall by reference numeral 4 is supported thereon so as to be rotatable along the vertical axis of the pedestal 1. This frame 4 consists of the base 5, the top beam 6 and the supports 7 which extend between the top beam 6 and the base 5. Together, the supports 7 and the top beam 6 form a tower on the base 5. The top beam 6 is supported so as to be rotatable on the conical top 3 of the pedestal 1, in a manner which is known per se, by means of a pivot bearing and radial bearing (not shown), while the base 5 is supported so as to be rotatable with respect to the cylindrical bottom pedestal section 2 by means of a series 13 of rolling elements 16. The boom which is denoted overall by reference numeral 8 is supported so as to be rotatable with respect to the base 5 along the bearings 9 with a horizontal axis. The angle of inclination of the boom 8 can be adjusted by means of the guy wires 10. In addition, hoisting cable 11 with hook 12 is passed over the boom 8.

According to a first possible embodiment as illustrated in FIG. 3, the series 13 of rolling elements 16 has an uninterrupted pulling belt 14 on which the end flanges 15 are provided. The series 13 of rolling elements 16 has a semicircular shape which is adapted to the cylindrical shape of the bottom pedestal section 2, in particular to the completely cylindrical running surface 25 which is provided thereon. On the inside or hollow side of the pulling belt 14, the rolling elements 16 are provided and are accommodated in a housing 17 in each case in pairs. These housings 17 are fitted to the inner surface of the pulling belt 14. In particular, these housings 17 may be rigidly attached to the pulling belt 14.

One such housing 17 is illustrated in FIG. 4. In this case, the rolling elements 16 each consist of two rollers 18 on a shaft 19 which is in turn supported in the housing 17 so as to be rotatable. The pinion 20 is also supported in the housing 17 so as to be rotatable. This pinion 20 cooperates with the gear ring 21 on the pedestal 1. By driving the pinion, for example using an electric or hydraulic motor, the base 5 can thus be rotated with respect to the pedestal 1. Due to the fact that the shape of the series 13 of rolling elements 16 is adapted to the cylindrical shape of the pedestal 1, and in particular to that of the running surface 25, all its rolling elements 18 are loaded evenly in the radial direction by a force R, as is illustrated in FIG. 5, when the tensile force F is exerted on the flanges 15 thereof.

In the illustrated embodiment, the gear ring 21 is situated in the centre of the running surface 25 which is thus in fact divided in two. A roller 18 of each rolling element 16 cooperates with the upper running surface portion and the other roller 18 cooperates with the bottom running surface portion. The series 13 of rolling elements 16 is thus held reliably in place with respect to the running surface 25 and the gear ring 21.

This tensile force F is caused by the torque which the boom 8, together with any load which is exerted thereon, exerts on the pedestal 1. As a result of this torque, the pedestal 1 is subjected to a force Fb on the base 5, via the frame 4, and to an equal but oppositely directed force Ft on the radial bearing of the conical top 3. The vertical load Fv is completely absorbed by the pivot bearing of the conical top 3. Since the series of rolling elements 13 is always on that side of the pedestal 1 which faces the boom 8, the crane jibs 22 pass this force Fb onto the series of rolling elements 13 which are connected to said crane jibs 22 by means of end flanges 15 of the strip-shaped pulling element 14, which causes the abovementioned tensile force F in the pulling belt 14, in which case the absolute value of Fb equals twice the absolute value of F. For reasons of stability, the crane jibs 22 are connected to each other by means of the cross beam 23.

FIGS. 6 and 7 illustrate a second variant of the series of rolling elements 13′. This series of rolling elements 13′ has a pulling belt 14′ which is provided between the end flanges 15 with a through-slot 24. The rolling elements 16 are accommodated in a housing 17′ which is situated on the outer side or convex side of the pulling belt 13′. The rolling elements 16 are positioned in such a manner with respect to the pulling belt 13′ that they project on the inner side or concave side thereof in such a way that they are evenly loaded and pushed against the circular running surface 25 on the cylindrical pedestal section 2, as is illustrated in FIG. 8.

In this embodiment as well, a pinion 20 may be provided in the housing 17′ for driving the base 5 in the direction of rotation with respect to the pedestal 1.

### LIST OF REFERENCE NUMERALS

1. Pedestal

2. Cylindrical pedestal section

3. Conical top

4. Frame

5. Base

6. Supporting beam

7. Supports

8. Boom

9. Bearing

10. Guy wire

11. Hoisting wire

12. Hook

13. Series of rolling elements

14. Pulling belt

15. End flange

16. Rolling element

17. Housing

18. Roller

19. Shaft

20. Pinion

21. Gear ring

22. Crane jib

23. Cross beam

24. Slot

25. Running surface

1-23. (canceled)

24. A crane, comprising a pedestal having a circular periphery, a base which is supported with respect to the pedestal so as to be rotatable along an axis parallel to the height direction of the pedestal, a boom which is fitted to the base so as to be rotatable along an axis transverse to the height direction of the pedestal, as well as adjustment means for adjusting the angle of inclination of the boom, which base is provided with a series of rolling elements which each have an axis which is parallel to the height direction of the pedestal, which series of rolling elements can be rolled over the circular periphery of the pedestal and which is always situated on that side of the pedestal facing the boom in such a manner that the series of rolling elements is subjected to a tensile load on account of the torque exerted on the pedestal by the boom and is held against the circular periphery of the pedestal, wherein the series of rolling elements comprises a pulling element which is strip-shaped, the width direction of the pulling element is parallel to the axis of the rolling elements, the thickness direction of the pulling element is radial with respect to the circular periphery of the pedestal, the height of the pulling element is greater than the width thereof and the rolling elements are suspended from the pulling element.

25. The crane according to claim 24, wherein the strip-shaped pulling element comprises at least one of a steel belt material, a laminate of layers having a high tensile strength, and a semi-circular part.

26. The crane according to claim 24, wherein both ends of the strip-shaped pulling element have flanges which are attached to the base, to which base the boom is fitted so as to be rotatable.

27. The crane according to claim 24, wherein the pulling element comprises at least one unit of belt material, which extends continuously over all rolling elements.

28. The crane according to claim 24, wherein the strip-shaped pulling element comprises parts of belt material which are rigidly attached to each other and which each extend over several rolling elements.

29. The crane according to claim 24, wherein the thickness of the strip-shaped pulling element is at least one order of magnitude smaller than the width thereof.

30. The crane according to claim 24, wherein a pinion is supported so as to be rotatable along a substantially vertical axis with respect to the pulling element and the pedestal is provided with a gear ring with which the pinion cooperates, which pinion is connected to a motor for rotating the base with respect to the pedestal.

31. The crane according to claim 24, wherein the rolling elements and/or a pinion are accommodated in an opening in the pulling element, and preferably wherein the pulling element comprises a continuous slot-shaped opening which accommodates the rolling elements and/or pinion.

32. The crane according to claim 24, wherein the rolling elements and/or a pinion are suspended from that surface of the pulling element which is turned away from the pedestal.

33. The crane according to claim 24, wherein the rolling elements and/or a pinion are suspended from that surface of the strip-shaped pulling element which faces the pedestal.

34. The crane according to claim 24, wherein the rolling elements are accommodated in a housing in pairs, which housing is attached to the pulling element, and preferably wherein a pinion is accommodated in the housing.

35. The crane according to claim 24, wherein the base comprises a tower the upper end of which is rotatably supported by means of a pivot bearing and a radial bearing on the top of the pedestal, over which tower the adjustment means of the boom are passed.

36. The crane according to claim 24, wherein the base comprises crane jibs which are attached to the ends of the strip-shaped pulling element, and preferably wherein a cross beam extends between the crane jibs.

37. The crane according to claim 24, wherein, between the crane jibs and/or the cross beam on the one hand, and the pivot bearing and radial bearing, supports extend for transferring vertical loads on the pivot bearing.

38. The crane according to claim 24, wherein the pedestal comprises a cylindrical foundation and a conical top which is provided on the foundation.

39. The crane according to claim 24, wherein the pulling element extends over all rolling elements, and preferably extends continuously over all rolling elements.

40. The crane according to claim 24, wherein a series of interlinked pulling elements each extend continuously over at least a quarter of the rolling elements, preferably over a third of the rolling elements, more preferably over half the rolling elements.
